(19) United States
(12) Patent Application Publication
(10) Pub. No.: US 2013/0229649 A1
(43) Pub. Date: Sep. 5, 2013

(54) OPTICAL BRILLOUIN SENSING SYSTEMS

(71) Applicants: Ming-Jun Li, Horseheads, NY (US); Shenping Li, Painted Post, NY (US); Richard Stephen Vodhanel, Red Bank, NJ (US)

(72) Inventors: Ming-Jun Li, Horseheads, NY (US); Shenping Li, Painted Post, NY (US); Richard Stephen Vodhanel, Red Bank, NJ (US)

(21) Appl. No.: 13/409,310

(22) Filed: Mar. 1, 2012

(51) Int. Cl. G01N 21/49; G01N 21/17

(52) U.S. Cl. 356/73.1

(57) ABSTRACT

According to one embodiment, an optical sensing system may include a gated optical amplifier, one or more triggering devices, and an optical coupler. The gated optical amplifier can receive a pulse signal and transform the pulse signal into an amplified pulse signal having an amplified peak portion. The triggering devices can control the gated optical amplifier such that the gated optical amplifier is in the lossy state while the baseline portion of the pulse signal is transformed and the gated optical amplifier is in the gain state while the peak portion of the pulse signal is transformed. The amplified pulse signal can be transmitted to the sensing optical fiber and a sensed optical signal can be received, when the sensing optical fiber is connected to the optical coupler. Optionally, a second pulse signal and the sensed optical signal can be combined and detected with a coherent balanced detection technique.

### BACKGROUND

1. Field

The present specification generally relates to optical sensing systems and, more specifically, to optical Brillouin sensing systems for interacting with sensing optical fibers.

2. Technical Background

Distributed sensors based on Brillouin scattering are attractive for forming optical fiber sensing systems used to measure the structural integrity of buildings, bridges, tunnels, dams and pipelines, as well as ships and airplanes. The most popular Brillouin optical fiber sensing system is Brillouin Optical Time Domain Reflectometry (BOTDR). This technique is similar to Rayleigh-based OTDR, where spontaneous Brillouin light backscattered from an intense pulse is recorded as a function of time. The frequency distribution of the backscattered signal is measured for each time step to determine a strain or a temperature change at each location. Like a conventional OTDR, a BOTDR requires access to a single fiber end only, which is convenient for many applications.

Another optical fiber sensing system utilizes Brillouin Optical Time Domain Analysis (BOTDA). This technique takes advantage of the Stimulated Brillouin Scattering (SBS) based on a pump-probe technique wherein an intense pump pulse interacts locally during its propagation with a weak counter-propagated continuous-wave (CW) probe. The gain experienced by the probe at each location can be analyzed by recording the probe amplitude in the time domain. The frequency difference between the pump and the probe is scanned step-by-step, and the local amplification can be retrieved for a given pump-probe frequency difference. The local gain spectrum can then be reconstructed by analyzing the gain at a given location as a function of frequency. BOTDA can require access to both optical fiber ends since the pump pulse and CW probe counter-propagate in the sensing fiber, which is a limitation in some situations.

High spatial resolution BOTDR/BOTDA fiber sensors with a long sensing range is desired by many applications. The spatial resolution of a BOTDR/BOTDA can be improved by using relatively short pump/probe pulses (i.e., short pump pulses for BOTDR, and pump/probe pulses for BOTDA). However, because the pulse repetition rate is correlated with the sensing range, shortening the width of the pulses, without changing the sensing range, will decrease the duty cycle of the pulse train. A shortened duty cycle can cause two issues for a BOTDR/BOTDA system. One is that the shortened the pulses can weaken the sensing signal. Moreover, the signal-to-noise ratio (SNR) of sensing optical signal can be degraded due to the finite extinction ratio of the pulses. Therefore, a tradeoff exists between spatial resolution and sensing sensitivity.

Furthermore, it is noted that a significant broadening and lowering of the Brillouin gain spectrum can be caused as the pulse width is reduced to the values comparable with the acoustic relaxation time (˜10 ns). Moreover, BOTDR or BOTDA sensitivity of Brillouin frequency can exhibit sensitivity to parameters that are not being measured. This sensitivity can lead to ambiguity in the measurement, as one does not know whether the observed Brillouin frequency shift is caused by the change of one parameter or another.

Accordingly, a need exists for alternative optical sensing systems for interacting with a sensing optical fiber.

### SUMMARY

According to one embodiment, an optical sensing system for interacting with a sensing optical fiber may include a light source, an optical modulator, a gated optical amplifier, one or more triggering devices, a first optical coupler, a second optical coupler, and an optical detector. The optical modulator can be optically coupled to the light source. The optical modulator can receive at least a portion of the optical energy of the light source and can transform the optical energy that is received into a pulse signal comprising a baseline portion and a peak portion having a greater amplitude than the baseline portion. The gated optical amplifier can be optically coupled to the optical modulator having a lossy state that attenuates signal and a gain state that amplifies signal. The gated optical amplifier can receive at least a portion of the pulse signal of the optical modulator and can transform the pulse signal that is received into an amplified pulse signal having an amplified peak portion. The one or more triggering devices can be communicatively coupled to the optical modulator and the gated optical amplifier. The one or more triggering devices can transmit an amplifier trigger signal to the gated optical amplifier to control the gated optical amplifier such that the gated optical amplifier is in the lossy state while the baseline portion of the pulse signal is transformed and the gated optical amplifier is in the gain state while the peak portion of the pulse signal is transformed. The first optical coupler can be optically coupled to the gated optical amplifier. The first optical coupler can transmit the amplified pulse signal to the sensing optical fiber when the sensing optical fiber is connected to the first optical coupler. The second optical coupler can be optically coupled to the first optical coupler. The second optical coupler can receive a sensed optical signal from the sensing optical fiber when the sensing optical fiber is connected to the first optical coupler. The optical detector can be optically coupled to the second optical coupler.

In another embodiment, an optical sensing system may include a light source, a sensing optical fiber, an optical modulator, an optical coupler, and an optical detector. The light source can output optical energy. The sensing optical fiber can be optically coupled to the light source. At least a portion of the optical energy of the light source can be transmitted into the sensing optical fiber. The sensing optical fiber can generate a sensed optical signal from the optical energy that is received. The optical modulator can be optically coupled to the light source. The optical modulator can receive at least a portion of the optical energy of the light source and can transform the optical energy that is received into a pulse signal comprising a baseline portion and a peak portion having greater amplitude than the baseline portion. The optical coupler can be optically coupled to the optical modulator and the sensing optical fiber. The optical coupler can combine the pulse signal of the optical modulator and the sensed optical signal of the sensing optical fiber into a combined optical signal. The optical detector can be optically coupled to the optical coupler. The optical detector can receive at least a portion of the combined optical signal of the optical coupler.

In a further embodiment, a method for Brillouin based sensing may include transforming a first pulse signal comprising a first baseline portion and a first peak portion having a greater amplitude than the first baseline portion into an amplified pulse signal having an amplified peak portion with a gated optical amplifier. The gated optical amplifier can have a lossy state that attenuates signal and a gain state that amplifies signal. The gated optical amplifier can be controlled such that the gated optical amplifier is in the lossy state while the first baseline portion of the first pulse signal is transformed and the gated optical amplifier is in the gain state while the first peak portion of the first pulse signal is transformed. The amplified pulse signal can be transmitted into a sensing optical fiber. A sensed optical signal can be received with an optical coupler. The sensed optical signal can be emitted from a point of interest along the sensing optical fiber. A second pulse signal comprising a second baseline portion and a second peak portion having greater amplitude than the second baseline portion can be received with the optical coupler. The sensed optical signal can be received contemporaneously with the second peak portion of the second pulse signal.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts an optical sensing system according to one or more embodiments shown and described herein;

FIG. 2 schematically depicts an optical sensing system according to one or more embodiments shown and described herein;

FIG. 3 schematically depicts an optical sensing system according to one or more embodiments shown and described herein;

FIG. 4 schematically depicts an optical sensing system according to one or more embodiments shown and described herein; and

FIG. 5 graphically depicts radio frequency spectra of probe pulse according to one or more embodiments shown and described herein.

### DETAILED DESCRIPTION

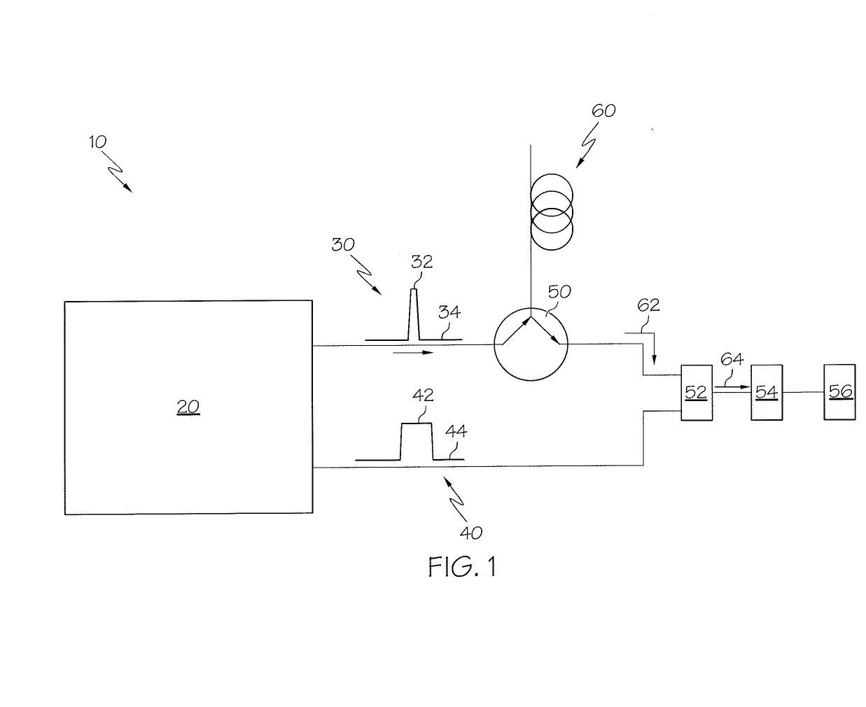

Reference will now be made in detail to embodiments of the present disclosure, examples of which are illustrated in the accompanying drawings. Whenever possible, the same reference numerals will be used throughout the drawings to refer to the same or like parts. One embodiment of the optical sensing system for interacting with a sensing optical fiber of the present disclosure is schematically depicted in FIG. 1, and is designated generally throughout by the reference numeral 10.

Throughout the present disclosure, reference will be made to the term light. The term “light” as used herein refers to various wavelengths of the electromagnetic spectrum, particularly wavelengths in the ultraviolet (UV), infrared (IR), and visible portions of the electromagnetic spectrum.

Referring now to FIG. 1, the optical sensing system 10 generally includes a pulsed light assembly 20 for generating a first pulse signal 30 and a second pulse signal 40. As used herein, the term “pulse” refers to a light signal having a baseline portion that is at a lower signal amplitude than a peak portion. Moreover, the peak portion of the each optical pulse is generally delineated by the full width at half maximum of the optical pulse. Accordingly, the pulsed light assembly 20 can generate a first pulse signal 30 comprising a first peak portion 32 and a first baseline portion 34, and a second pulse signal 40 comprising a second peak portion 42 and a second baseline portion 44.

Additionally, the optical pulses described herein generally include a rapid transient portion as the signal changes from the baseline portion to the peak portion. Accordingly, each pulse can include a substantially triangular waveform, a substantially square waveform, a substantially Gaussian waveform, or any other waveform having a peak that is distinguishable from a baseline. In some embodiments, it may be desirable for the baseline portion to be substantially equal to about zero amplitude. However, it is not necessary for the baseline portion to have an amplitude that is substantially equal to about zero. Furthermore, it is noted that the term “signal” means a waveform (e.g., electrical, optical, magnetic, mechanical or electromagnetic), such as a continuous wave, a pulsed wave, or the like, capable of traveling through a medium.

Referring still to FIG. 1, the optical sensing system 10 can comprise an optical circulator 50 for optically coupling the pulsed light assembly 20 with a sensing optical fiber 60. The optical circulator 50 is an optical coupler that can be used to control bi-directional propagation of light. For example, the optical circulator 50 can include any number of ports having non-reciprocal optics, i.e., changes in the properties of light passing through one port to another port are not reversed when the light passes through in the opposite direction. Specifically, the optical circulator 50 can be a three-port optical circulator designed such that light entering any port exits from the next port. Accordingly, if light enters a first port it can be emitted from a second port. If some of the emitted light is reflected back to the second port, the reflected light can exit from a third port without exiting the first port.

The optical sensing system 10 may further comprise a coupler 52 for combining the second pulse signal 40 with a sensed optical signal 62. For example, the coupler 52 can be a 50:50 2×2 coupler. Accordingly, the 2×2 coupler can be configured to receive two optical input signals, split each optical input signal into two output signals having about 50% of its respective input signal level, and combine one output signal corresponding to each of the optical input signals into a combined signal. The resulting combined signal would then be the superimposed combination of about 50% of each of the input optical signals. The ratio of the coupler 52 can be set to any desired level for a 2×2 coupler such as, for example, 90:10, 80:20 or any other ratio that sums into a value less than or equal to about 100.

In some embodiments, it may desirable to further include one or more optical isolators to control the propagation direction of light. Specifically, an optical isolator can be utilized to allow light to propagate in a forward direction for transmission or reception, while absorbing or displacing light propagating in the reverse direction to mitigate undesired feedback. Optical isolators can be polarization-dependent and polarization-independent throughout the electromagnetic spectrum. Thus, it should now be understood that, the optical sensing system 10 may include one or more optical couplers for transmitting optical signals, receiving optical signals, combining optical signals, splitting optical signals, or combinations thereof. Accordingly, while specific optical couplers are described herein, the functions performed by any of the optical couplers described herein can be replaced with an equivalent alternative combination of optical couplers such as, for example, an optical isolator, an optical circulator, optical splitter, an optical combiner, a coupler, or the like.

The optical sensing system 10 can comprise an optical detector 54 that is optically coupled to the coupler 52 for detecting the combined optical signal 64 from the coupler 52. The optical detector 54 can be any device configured to detect light and transform the detected light into a signal indicative of a characteristic of the detected light (e.g., optical power). Accordingly, the optical detector 54 can include one or more photodetectors such as, for example, a photodiode, photoresistor, a phototransistor, or the like. In one embodiment, the optical detector 54 can include two matched photodetectors for coherent detection of two coherent combined signals from the coupler 52. Without being bound to any particular theory, it is believed that coherent balanced detection can provide improved sensing sensitivity, and thus improved spatial resolution. It is noted that, the phrase “optically coupled,” as used herein, means that components are capable of exchanging light with one another via one or more intermediary mediums such as, for example, electromagnetic signals via air, optical signals via optical waveguides, optical signals via optical couplers, or the like.

Referring still to FIG. 1, the optical sensing system 10 can comprise a signal processor 56 that is communicatively coupled to the optical detector 54. The signal processor 56 can include one or more processors, which can be any device capable of executing machine readable instructions. Accordingly, the processor can be a controller, an integrated circuit, a microchip, a computer, or any other computing device. The each processor can further include and/or be communicatively coupled to a memory such as, for example, RAM, ROM, a flash memory, a hard drive, or any device capable of storing machine readable instructions. As used herein, the term “communicatively coupled” means that the components are capable of exchanging data signals with one another such as, for example, electrical signals via conductive medium, electromagnetic signals via air, optical signals via optical waveguides, and the like.

Embodiments of the present disclosure can comprise logic for transforming a signal indicative of a characteristic of the detected light into a physical parameter (e.g., temperature or a strain) using Brillouin based analysis such as, but not limited to, Brillouin optical time domain analysis (BOTDA) and Brillouin optical time domain reflectometry (BOTDR). Accordingly, the logic can include machine readable instructions or an algorithm written in any programming language of any generation (e.g., 1GL, 2GL, 3GL, 4GL, or 5GL) such as, e.g., machine language that may be directly executed by the processor, or assembly language, object-oriented programming (OOP), scripting languages, microcode, etc., that may be compiled or assembled into machine readable instructions and stored on a machine readable medium. Alternatively, the logic or algorithm may be written in a hardware description language (HDL), such as logic implemented via either a field-programmable gate array (FPGA) configuration or an application-specific integrated circuit (ASIC), and their equivalents. Accordingly, the logic may be implemented in any conventional computer programming language, as pre-programmed hardware elements, or as a combination of hardware and software components.

As is noted above, the optical sensing system 10 can optionally include a sensing optical fiber 60, i.e., some embodiments of the optical sensing system 10 can be integral with the sensing optical fiber 60, selectively optically coupled to the sensing optical fiber 60, or may not include any sensing optical fiber 60. The sensing optical fiber 60 is generally a flexible, substantially transparent fiber that operates as an optical waveguide and can be made from a transmissive material such as silica. The sensing optical fiber 60 is generally configured to modulate the intensity, phase, polarization, wavelength, or transit time of light in the fiber when acted upon by the property that is to be detected by the sensing optical fiber 60. Accordingly, the sensing optical fiber 60 can be utilized to measure strain, temperature, or pressure. The embodiments described herein, can include sensing optical fiber 60 configured to support any number of modes. Accordingly, the sensing optical fiber 60 can be a single-mode fiber (SMF), a few-mode fiber (FMF), or a multi-mode fibers (MMF).

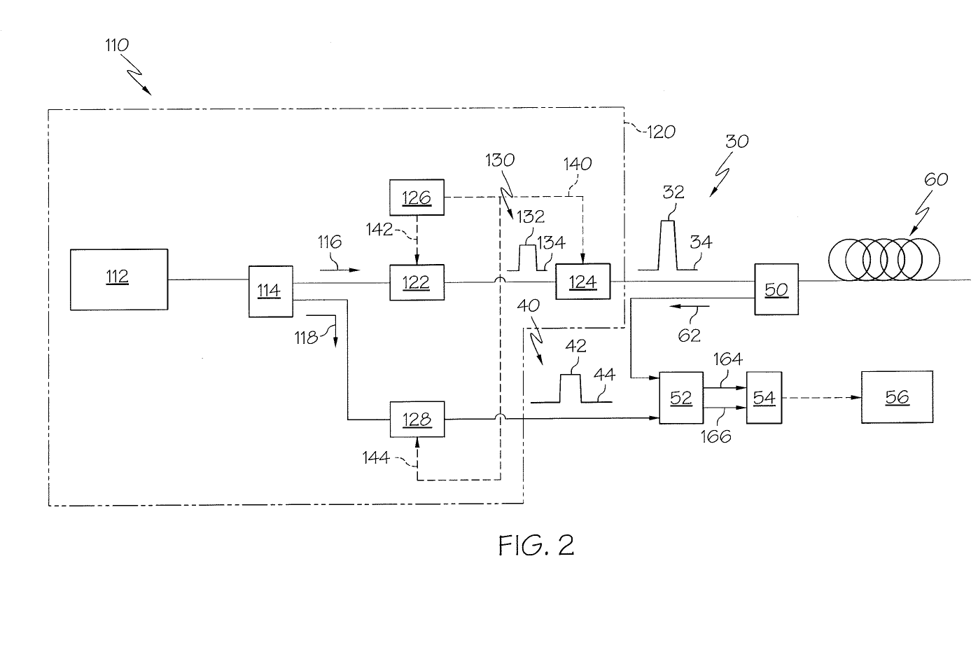

Referring now to FIG. 2, an embodiment of an optical sensing system 110 that can be utilized for BOTDR is schematically depicted. The optical sensing system 110 comprises a pulsed light assembly 120 for generating a first pulse signal 30 and a second pulse signal 40. The pulsed light assembly 120 can include a continuous wave laser 112 that operates as a light source for the optical sensing system 110 by emitting a substantially continuous signal of optical energy. A 1×2 optical splitter 114 can be optically coupled to the continuous wave laser 112 and configured to split the optical energy emitted by the continuous wave laser 112 into two portions.

The first portion 116 of the optical energy can be utilized as pump light. Specifically, a first optical modulator 122 can be optically coupled to the 1×2 optical splitter 114. The first optical modulator 122 can convert the first portion 116 of the optical energy into a pump pulse signal 130 having a pump peak portion 132 and a pump baseline portion 134. As used herein, the phrase “optical modulator” refers to a device that can be utilized to modulate a parameter of a light signal such as, but not limited to, amplitude modulators, phase modulators, polarization modulators, or the like. Suitable optical modulators include but are not limited to electro-optic modulators, acousto-optic modulators, magneto-optic modulators, mechano-optical modulators, or combinations thereof. Additionally, it is noted that while FIG. 2 depicts external modulation, in some embodiments modulation can be performed by direct modulation of the light source.

The pulsed light assembly 120 may further include a gated optical amplifier 124 optically coupled to the first optical modulator in order to transform the pump pulse signal 130 into the first pulse signal 30. The gated optical amplifier can be any optical device having a selectively activated lossy state that attenuates signal and a selectively activated gain state that amplifies signal. In some embodiments, the gated optical amplifier 124 can be a semiconductor optical amplifier. The semiconductor optical amplifier can be an electrically controlled optical amplifier that includes a semiconductor gain medium made from a direct band gap semiconductor such as, but not limited to, group III-V compounds (e.g., GaAs/AlGaAs, InP/InGaAs, InP/InGaAsP and InP/InAlGaAs). In further embodiments, the semiconductor optical amplifier can a have a lossy state with a very high loss such as, for example, a loss of greater than about 35 dB, or in another embodiment a loss of up to about 70 dB.

The pulsed light assembly 120 may further include one or more triggering devices 126 for controlling modulation and amplification. Specifically, the one or more triggering devices 126 can be communicatively coupled to the first optical modulator 122 and the gated optical amplifier 124. The one or more triggering devices 126 can each be a signal generator configured to generate any desired triggering signal such as, for example, an electronic signal, or an optical signal.

Additionally, the one or more triggering devices 126 can be communicatively coupled to one or more delay controllers. Specifically, the one or more delay controllers can each be a processor that executes machine readable instructions to control the timing of each signal output from the one or more triggering devices 126. Accordingly, the one or more triggering devices 126 can be configured to control the modulation of the first portion 116 of the optical energy into the pump pulse signal 130 (i.e., amplitude modulation). The one or more triggering devices 126 can also be configured to control the gated optical amplifier 124.

Specifically, the one or more triggering devices 126 can transmit an amplifier trigger signal 140 to the gated optical amplifier 124 to control the gated optical amplifier 124 such that the gated optical amplifier 124 is in the lossy state while pump baseline portion 134 of the pump pulse signal 130 is transformed by the gated optical amplifier 124, and the gated optical amplifier 124 is in the gain state while the pump peak portion 132 of the pump pulse signal 130 is transformed by the gated optical amplifier 124. Accordingly, the gated optical amplifier 124 can be utilized to increase signal-to-noise ratio by amplifying the pump peak portion 132 of the pump pulse signal 130 and attenuating the pump baseline portion 134 of the pump pulse signal 130.

In one embodiment, the delay controller can execute machine readable instructions to cause the one or more triggering devices 126 to transmit the amplifier trigger signal 140 to the gated optical amplifier 124 a gate delay time period after the pump peak portion 132 of the pump pulse signal 130 is transmitted from the first modulator. Specifically, the gate delay time period is substantially equal to the travel time required for the pump peak portion 132 of the pump pulse signal 130 to travel from the first optical modulator 122 to the gated optical amplifier 124. When the one or more triggering devices 126 transmit a first modulation signal 142 to the first optical modulator 122 in order to control the modulation, the gate delay time period can be determined based upon the timing of the first modulation signal 142. In further embodiments, the gate delay time period can be determined based upon detection of the pump pulse signal 130.

The optical sensing system 110 may further comprise an optical coupler or an optical circulator 50 optically coupled to the gated optical amplifier 124. Accordingly, when the sensing optical fiber 60 is optically coupled to the optical circulator 50, the first pulse signal 30 can be transmitted into the sensing optical fiber 60. Moreover, a sensed optical signal 62 can be generated within the sensing optical fiber 60 by the first pulse signal 30 and received by the optical circulator 50. For example, the sensed optical signal 62 can be a back reflected Brillouin scattered signal. It is noted that, while the sensing optical fiber 60 is depicted as a SMF, the sensing optical fiber 60 can be a FMF or a MMF.

Referring still to FIG. 2, the second portion 118 of the optical energy can be utilized as local oscillator light. Specifically, the pulsed light assembly 120 may further comprise a second optical modulator 128 optically coupled to the 1×2 optical splitter 114. The second optical modulator 128 can transform the second portion 118 of the optical energy into a second pulse signal 40 having a second peak portion 42 and a second baseline portion 44.

In one embodiment, the delay controller can execute machine readable instructions to cause the one or more triggering devices 126 to transmit a local trigger signal 144 to the second optical modulator 128 in order to control parameters of the second pulse signal 40 such as the timing of the transmission of the second pulse signal 40 and the duration of the second peak portion 42 of the second pulse signal 40. Specifically, the second optical modulator 128 can be controlled such that the second pulse signal 40 is transmitted a calculated time period after the first peak portion 32 of the first pulse signal 30 is transmitted from the gated optical amplifier 124. Accordingly, a point of interest along the sensing optical fiber 60 can be detected by setting an appropriate calculated time period. The calculated time period can be based upon the round trip travel time needed for the first peak portion 32 of the first pulse signal 30 to travel from the gated optical amplifier 124 to the point of interest along the sensing optical fiber 60. The round trip travel time can be equal to the sum of the time required for the first peak portion 32 of the first pulse signal 30 to travel from the gated optical amplifier 124 to the point of interest along the sensing optical fiber 60 and the amount of time required for the sensed optical signal 62 to travel from the point of interest along the sensing optical fiber 60 to the coupler 52 minus the travel time required for the second peak portion 42 of the second pulse signal 40 to travel from the second optical modulator 128 to the coupler 52. It is noted that, while the calculated time period is described herein as being derived from the round trip travel time, the calculated time period can be set to any value such that the second peak portion 42 of the second pulse signal 40 arrives at the coupler 52 contemporaneous with the sensed optical signal 62 from the point of interest along the sensing optical fiber 60.

Furthermore, it is noted that a range of detection along the sensing optical fiber 60 can be controlled by the duration of the second peak portion 42 of the second pulse signal 40. For a relatively long duration of the second peak portion 42 a relative large length of the sensing optical fiber 60 can be detected, and for a relatively short duration of the second peak portion 42 a relative small length of the sensing optical fiber 60 can be detected. For example, a pulse width of about 100 ns can correspond to a range of about 10 m.

The optical sensing system 110 can comprise an optical detector 54 comprising balanced photodetectors. The coupler 52 can combine the second pulse signal 40 and the sensed optical signal 62 into a first combined signal 164 and a second combined signal 166. The first combined signal 164 and the second combined signal 166 can each include a superposition of about 50% of the second pulse signal 40 and about 50% of the sensed optical signal 62, i.e., the coupler 52 can be a 2×2 coupler. Accordingly, the output of the coupler 52 can be detected using a balanced photodetector. Once detected, the optical detector 54 can transform the first combined signal 164 and the second combined signal 166 into a data signal. The data signal can then be transmitted to the signal processor 56 and processed according to Brillouin based analysis algorithms.

As is noted above, it is believed that coherent balanced detection can provide improved spatial resolution. For example, in an embodiment optical detector 54 comprises balanced photodetectors and transforms light into an output photocurrent, the photocurrent of the balanced photodetectors can be expressed as:

I=2R\sqrt{PₛP_{LO}} cos [2π(νₛ−ν_{LO})t+(φₛ−φ_{LO}+π/2)], (1)

where R is the balanced photodetector responsivity, Pₛ is the optical power level of the sensed optical signal, P_{LO} is the optical power level of the second pulse signal, νₛ is the optical frequency of the sensed optical signal and ν_{LO} the optical frequency of the second pulse signal, and φₛ is the phase of sensed optical signal, and _{LO} is the phase of the second pulse signal. From Eq. 1, the photocurrent of the balanced photodetectors can be increased by increasing the optical power level of the second pulse signal. Such an increase in photocurrent can enhance spatial resolution, sensing distance, sensitivity, acquisition time, or a combination thereof with BOTDR and/or BOTDA.

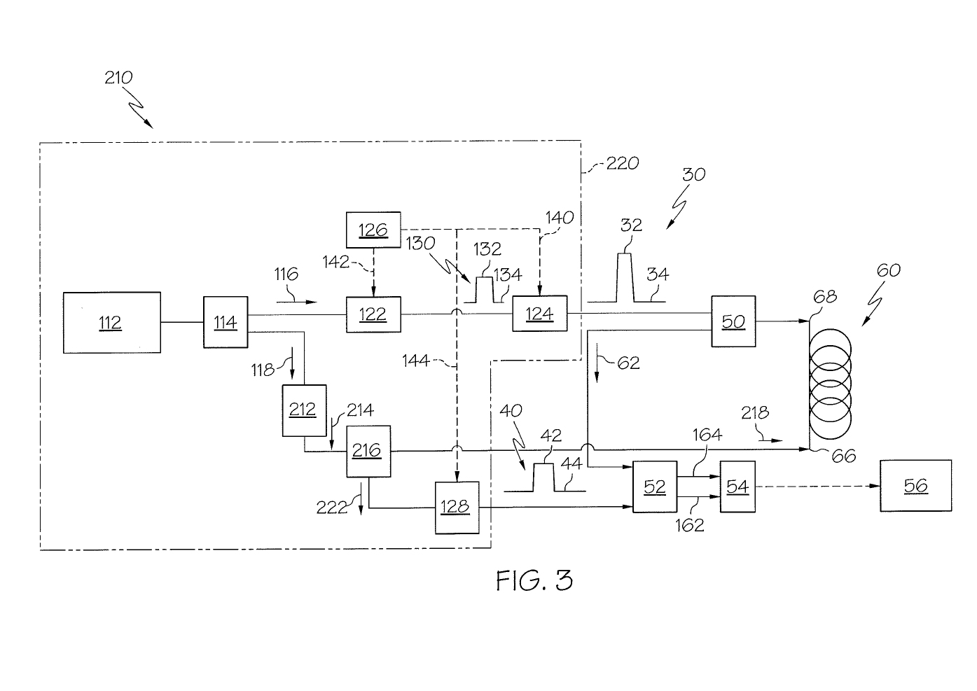

Referring now to FIG. 3, an embodiment of the optical sensing system 210 that can be utilized for BOTDA is schematically depicted. The optical sensing system 210 comprises a pulsed light assembly 220 for generating a first pulse signal 30, a second pulse signal 40, and a continuous wave light signal 218. The pulsed light assembly 220 is similar to the pulsed light assembly 120 (FIG. 2), with the addition of components configured to emit the continuous wave light signal 218.

Specifically, the pulsed light assembly 220 may further comprise a wavelength shifter 212 such as, for example, an optical phase modulator or a single sideband electro-optic modulator, for shifting the frequency of the second portion 118 of the optical energy. The frequency shift can be set to be about equal to the Brillouin frequency shift induced by the sensing optical fiber 60. In one embodiment, the wavelength shifter 212 can be optically coupled to the 1×2 optical splitter 114, such that the second portion 118 of the optical energy is transformed into a frequency shift signal 214. The wavelength shifter 212 can also be optically coupled to a 1×2 optical splitter 216, such that frequency shift signal 214 is divided into the continuous wave light signal 218 and a second shifted frequency signal 222.

The 1×2 optical splitter 216 can be optically coupled to a first end 66 of the sensing optical fiber 60, such that the continuous wave light signal 218 is transmitted into the first end 66 of the sensing optical fiber 60. Additionally, the optical circulator 50 can be optically coupled to a second end 68 of the sensing optical fiber 60, such that the first pulse signal 30 is transmitted into the second end 68 of the sensing optical fiber 60. The 1×2 optical splitter 216 can also be optically coupled to the second optical modulator 128, such that the second shifted frequency signal 222 is transformed by the second optical modulator 128 into the second pulse signal 40. The detection and operation of the optical sensing system 210 are similar to that of the optical sensing system 110 (FIG. 2), as is described above.

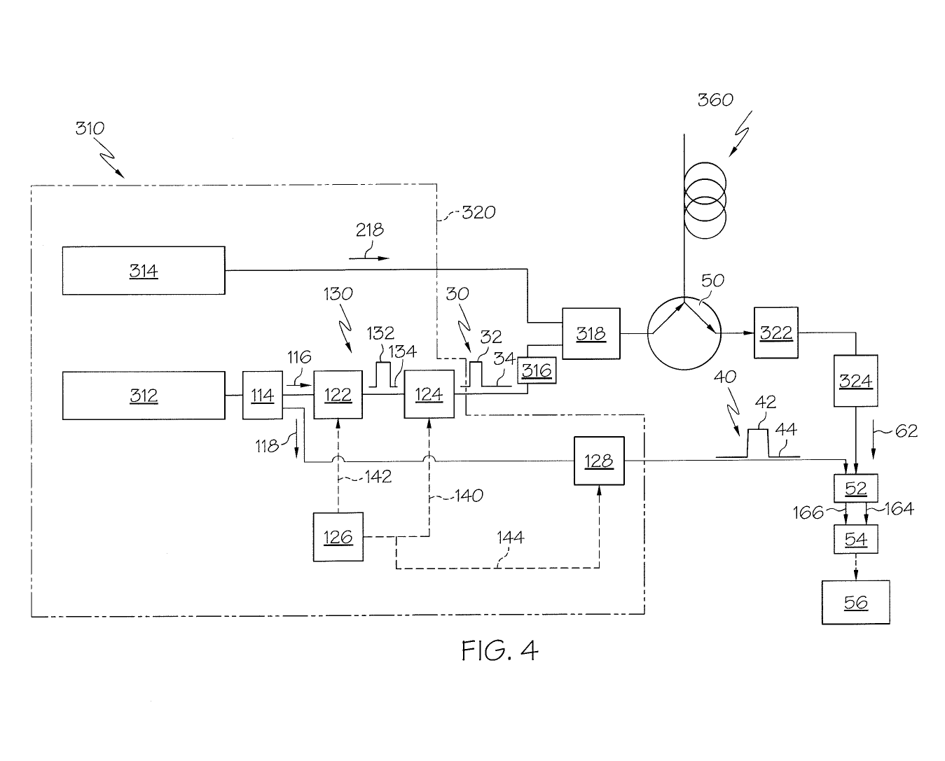

Referring now to FIG. 4, an embodiment the optical sensing system 310 that can be utilized for BOTDR is schematically depicted. The optical sensing system 310 comprises a pulsed light assembly 320 for generating a first pulse signal 30, a second pulse signal 40, and a continuous wave light signal 218. The pulsed light assembly 320 is similar to the pulsed light assembly 220 (FIG. 3), with the addition of components configured to emit the first pulse signal 30 and the continuous wave light signal 218 into a sensing optical FMF 360.

The pulsed light assembly 320 may comprise a tunable continuous wave laser 312 that operates as a light source for the optical sensing system 310 by emitting a substantially continuous signal of optical energy. A 1×2 optical splitter 114 can be optically coupled to the tunable continuous wave laser 312 and configured to split the optical energy emitted by the tunable continuous wave laser 312 into a first portion 116 of the optical energy and a second portion 118 of the optical energy. The first portion 116 of the optical energy and the second portion 118 of the optical energy are transformed by the pulsed light assembly 320 into the first pulse signal 30 and the second pulse signal 40 in a manner similar to that of the pulsed light assembly 120 (FIG. 2).

The pulsed light assembly 320 may further comprise a continuous wave laser 314 that operates as a light source for generating the continuous wave light signal 218. In one embodiment, the tunable continuous wave laser 312 and the continuous wave laser 314 can be configured to generate different frequencies of light. Specifically, the frequencies can differ to account for the phase matching frequency difference between LP₀₁ and LP₁₁ modes of the sensing optical FMF 360.

Referring still to FIG. 4, the optical sensing system 310 may further comprise an optical mode converter 316 for converting the first pulse signal 30 from a fundamental mode into a higher mode (e.g., from LP₀₁ to LP₁₁). Accordingly, the optical mode converter 316 can be coupled to the gated optical amplifier 124. The first pulse signal 30 can then be launched into the sensing optical FMF 360.

In one embodiment, the continuous wave laser 314 and the optical mode converter 316 can be optically coupled to a 2×1 optical coupler 318. The 2×1 optical coupler 318 can combine the first pulse signal 30 and the continuous wave light signal 218 such that the first pulse signal 30 travels along a different mode of the sensing optical FMF 360 than the continuous wave light signal 218. Specifically, the 2×1 optical coupler 318 can be optically coupled to the optical circulator 50. Accordingly, when the sensing optical FMF 360 is optically coupled to the optical circulator 50, the first pulse signal 30 and the continuous wave light signal 218 can be transmitted into the sensing optical FMF 360. A different port of the optical circulator 50 can be optically coupled to an optical mode converter 322 for converting the sensed optical signal 62 from the higher mode to the fundamental mode (e.g., from LP₁₁ to LP₀₁). The sensed optical signal 62 can then be filtered by an optical filter 324 and transmitted to the optical detector 54. Detection and operation of the optical sensing system 310 are similar to that of the optical sensing system 110 (FIG. 2), as is described above.

### EXAMPLE

The embodiments described herein will be further clarified by the following example.

An embodiment of the optical sensing system 310 was constructed and tested. In the tested embodiment, a continuous wave narrow-linewidth fiber laser and an erbium doped fiber amplifier (EDFA) were utilized to form the continuous wave laser 314. The tunable continuous wave laser 312 was modulated externally with the first optical modulator 122. A semiconductor optical amplifier (SOA) was used as the gated optical amplifier 124 to optically gate and amplify the pump pulse signal 130 output from the first optical modulator 122. Another SOA was used as the second optical modulator 128 to output a second pulse signal 40 having a pulse width of about 7 ns. An electrical pulse generator was utilized as the one or more triggering devices 126 to generate the amplifier trigger signal 140, the first modulation signal 142 and the local trigger signal 144. Accordingly, the timing between the SOA's, and the first optical modulator 122 was controlled by the electrical pulse generator to synchronize the first pulse signal 30 and the second pulse signal 40.

The first pulse signal 30 having a 100 kHz repetition rate was launched into the LP₁₁ mode of a 15.96 km two-mode fiber, which was utilized as the sensing optical FMF 360. The continuous wave light signal 218 was launched into the LP₀₁ mode of the 15.96 km two-mode fiber. The sensed optical signal 62 (i.e., the signal reflected by the two-mode fiber) was converted from high order mode LP₁₁ mode into the fundamental mode LP₀₁ by the optical mode converter 322. The sensed optical signal 62 and second pulse signal 40 were combined and detected by a coherent balanced photodetector with a bandwidth of 20 GHz. The output of the balanced photodetector was monitored by an electrical spectral analyzer.

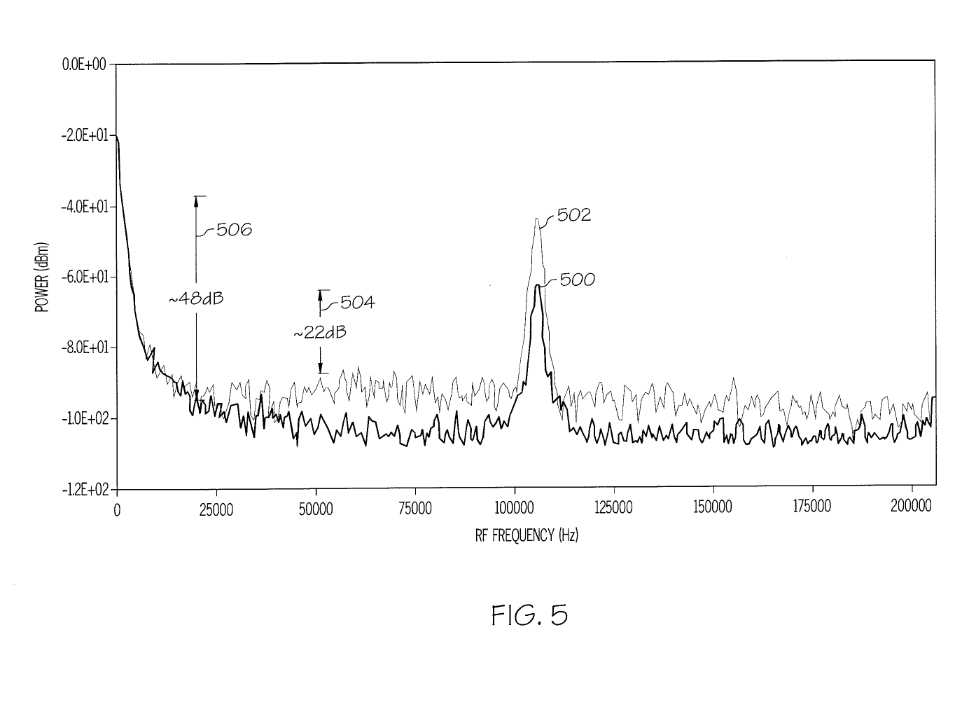

FIG. 5 depicts experimental results of the radio frequency spectra of the first pulse signal 30 without use of the SOA (non-amplified spectrum 500) and with use of the SOA (amplified spectrum 502). The non-amplified signal-to-noise ratio 504 corresponding to the non-amplified spectrum 500 was about 22 dB and amplified signal-to-noise ratio 506 corresponding to the amplified spectrum 502 was about 48 dB. It was experimentally determined that the improvement in signal-to-noise ratio can reduce the confusion in specifying the location of the sensing region (i.e., the portion of the sensing fiber to detect) and the error in detecting the Brillouin frequency. Accordingly, improvements were made in measuring strain and temperature.

It should now be understood that the embodiments described herein can be utilized to improve the performance of BOTDR/BOTDA fiber sensors. For example, the use of a pulsed local oscillator to interact with the sensing optical signal in coherent balanced detection can improve performance compared to regular sensing systems where the local oscillator light is continuous wave light. Specifically, a pulsed local oscillator having equivalent average power to a continuous wave local oscillator can have higher peak powers than the continuous wave local oscillator. Accordingly, the embodiments described herein can be used to interact with the pulsed local oscillator light with the sensing optical signal without saturating the balanced photodetectors, and improve spatial resolution, sensing distance, sensitivity, and/or acquisition time of a BOTDR/BOTDA fiber sensor. Moreover, a gated optical amplifier (e.g., SOA) can be used to gate and amplify the probe/pump pulses to increase the signal-to-noise ratio of probe/pump pulses. Such improvements in the signal-to-noise ratio of probe/pump pulses, can increase the signal-to-noise ratio of the sensing signal to improve the performance of the BOTDR/BOTDA fiber sensor.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. An optical sensing system for interacting with a sensing optical fiber, the system comprising:
at least one light source that outputs optical energy;
an optical modulator optically coupled to the light source, wherein the optical modulator receives at least a portion of the optical energy of the light source and transforms the optical energy that is received into a pulse signal comprising a baseline portion and a peak portion having a greater amplitude than the baseline portion;
a gated optical amplifier optically coupled to the optical modulator having a lossy state that attenuates signal and a gain state that amplifies signal, wherein the gated optical amplifier receives at least a portion of the pulse signal of the optical modulator and transforms the pulse signal that is received into an amplified pulse signal having an amplified peak portion;
one or more triggering devices communicatively coupled to the optical modulator and the gated optical amplifier, wherein the one or more triggering devices transmit an amplifier trigger signal to the gated optical amplifier to control the gated optical amplifier such that the gated optical amplifier is in the lossy state while the baseline portion of the pulse signal is transformed and the gated optical amplifier is in the gain state while the peak portion of the pulse signal is transformed;
a first optical coupler optically coupled to the gated optical amplifier, wherein the first optical coupler transmits the amplified pulse signal to the sensing optical fiber when the sensing optical fiber is connected to the first optical coupler;
a second optical coupler optically coupled to the first optical coupler, wherein the second optical coupler receives a sensed optical signal from the sensing optical fiber when the sensing optical fiber is connected to the first optical coupler; and
an optical detector optically coupled to the second optical coupler.

2. The optical sensing system of claim 1, further comprising a second optical modulator optically coupled to the light source and the second optical coupler, wherein the second optical modulator receives at least a portion of the optical energy of the light source and transforms the optical energy that is received into a second pulse signal comprising a second baseline portion and a second peak portion having a greater amplitude than the second baseline portion.

3. The optical sensing system of claim 2, wherein the second optical coupler combines the second pulse signal and the sensed optical signal into a combined optical signal, divides the combined optical signal into two combined sensed signals, and the optical detector receives the two combined sensed signals.

4. The optical sensing system of claim 3, wherein the combined optical signal is a superposition of the second pulse signal and the sensed optical signal.

5. The optical sensing system of claim 2, further comprising a delay controller communicatively coupled to the one or more triggering devices, wherein the second optical modulator is communicatively coupled to the one or more triggering devices and the delay controller executes machine readable instructions to cause the one or more triggering devices to transmit a trigger signal a calculated time period after the amplified peak portion of the amplified pulse signal is transmitted from the gated optical amplifier.

6. The optical sensing system of claim 1, wherein the sensing optical fiber is a single mode optical fiber.

7. The optical sensing system of claim 1, wherein the sensed optical signal is a back reflected Brillouin scattered signal.

8. An optical sensing system, comprising:
a light source that outputs optical energy;
a sensing optical fiber optically coupled to the light source, wherein at least a portion of the optical energy of the light source is transmitted into the sensing optical fiber and the sensing optical fiber generates a sensed optical signal from the optical energy that is received;
an optical modulator optically coupled to the light source, wherein the optical modulator receives at least a portion of the optical energy of the light source and transforms the optical energy that is received into a pulse signal comprising a baseline portion and a peak portion having a greater amplitude than the baseline portion;
an optical coupler optically coupled to the optical modulator and the sensing optical fiber, wherein the optical coupler combines the pulse signal of the optical modulator and the sensed optical signal of the sensing optical fiber into a combined optical signal; and
an optical detector optically coupled to the optical coupler, wherein the optical detector receives at least a portion of the combined optical signal of the optical coupler.

9. The optical sensing system of claim 8, further comprising:
a second optical modulator optically coupled to the light source, wherein the second optical modulator receives at least a portion of the optical energy of the light source and transforms the optical energy that is received into a second pulse signal comprising a second baseline portion and a second peak portion having a greater amplitude than the second baseline portion; and
a gated optical amplifier optically coupled to the second optical modulator having a lossy state that attenuates signal and a gain state that amplifies signal, wherein the gated optical amplifier receives at least a portion of the second pulse signal of the second optical modulator, transforms the second pulse signal that is received into an amplified pulse signal having an amplified peak portion, and transmits the amplified pulse signal to the sensing optical fiber.

10. The optical sensing system of claim 9, further comprising:
one or more triggering devices communicatively coupled to the optical modulator; and
a delay controller communicatively coupled to the one or more triggering devices, wherein the delay controller executes machine readable instructions to cause the one or more triggering devices to transmit a trigger signal a calculated time period after the amplified peak portion of the amplified pulse signal is transmitted from the gated optical amplifier, and wherein the calculated time period is substantially equal to a round trip travel time needed for the amplified peak portion of the amplified pulse signal to travel from the gated optical amplifier to a point of interest along the sensing optical fiber.

11. The optical sensing system of claim 10, wherein the one or more triggering devices are communicatively coupled to the gated optical amplifier and the delay controller executes the machine readable instructions to cause the one or more triggering devices to transmit an amplifier trigger signal to the gated optical amplifier a gate delay time period after the peak portion of the pulse signal is transmitted from the optical modulator, and wherein the gate delay time period is substantially equal to a pump travel time for the peak portion of the pulse signal to travel from the optical modulator to the gated optical amplifier.

12. The optical sensing system of claim 9, wherein:
the light source comprises at least one continuous wave laser;
the light source transmits a continuous wave signal to a first end of the sensing optical fiber; and
the amplified pulse signal is transmitted to a second end of the sensing optical fiber.

13. The optical sensing system of claim 8, wherein the sensed optical signal is a back reflected Brillouin scattered signal.

14. A method for Brillouin based sensing comprising:
transforming a first pulse signal comprising a first baseline portion and a first peak portion having a greater amplitude than the first baseline portion into an amplified pulse signal having an amplified peak portion with a gated optical amplifier, wherein the gated optical amplifier has a lossy state that attenuates signal and a gain state that amplifies signal;
controlling the gated optical amplifier such that the gated optical amplifier is in the lossy state while the first baseline portion of the first pulse signal is transformed and the gated optical amplifier is in the gain state while the first peak portion of the first pulse signal is transformed;
transmitting the amplified pulse signal into a sensing optical fiber;
receiving a sensed optical signal with an optical coupler, wherein the sensed optical signal is emitted from a point of interest along the sensing optical fiber; and
receiving a second pulse signal comprising a second baseline portion and a second peak portion having a greater amplitude than the second baseline portion with the optical coupler, wherein the sensed optical signal is received contemporaneously with the second peak portion of the second pulse signal.

15. The method of claim 14, further comprising:
dividing a continuous wave optical signal into multiple optical input signals;
transforming one of the multiple optical input signals into the first pulse signal with a first optical modulator; and
transforming one of the multiple optical input signals into the second pulse signal with a second optical modulator.

16. The method of claim 14, further comprising:
transmitting a continuous wave optical signal into a first mode of the sensing optical fiber, wherein the amplified pulse signal is transmitted into a second mode of the sensing optical fiber.

17. The method of claim 14, wherein the sensing optical fiber is a few-mode optical fiber or a multimode optical fiber.

18. The method of claim 14, further comprising:
combining the second pulse signal and the sensed optical signal into a combined optical signal with a second optical coupler, wherein the combined optical signal is a superposition of the second pulse signal and the sensed optical signal;
dividing the combined optical signal into coherent combined sensed signals; and
receiving the coherent combined sensed signals with a balanced photodetector.

19. The method of claim 18, further comprising:
transforming a data signal indicative of the coherent combined sensed signals into a physical property based upon a Brillouin frequency shift.

20. The method of claim 19, wherein the physical property is a temperature, a strain, or both.
